(19) United States
(12) Patent Application Publication
(10) Pub. No.: US 2008/0130896 A1
(43) Pub. Date: Jun. 5, 2008

(54) METHOD AND SYSTEM FOR INCREASING THE ACCURACY AND SECURITY OF DATA CAPTURE FROM A PAPER FORM

(76) Inventors: Paul Gerrard Wernet, Annandale, VA (US); Dean Joseph Whitmore, Alexandria, VA (US)

Correspondence Address: Muncy, Geissler, Olds & Lowe, PLLC, P.O. BOX 1364, FAIRFAX, VA, 22038-1364, US

(21) Appl. No.: 11/940,278

(22) Filed: Nov. 14, 2007

Related U.S. Application Data
(63) Continuation-in-part of application No. 10/478,129, filed on Jun. 7, 2004, now abandoned.

(51) Int. Cl. H04L 9/00

(52) U.S. Cl. 380/277; 380/51

(57) ABSTRACT

A method and system is provided for increasing the accuracy and security of data capture from a paper form where the form was completed electronically and printed out prior to submission. The invention utilizes two-dimensional barcode technology to dynamically capture data entered electronically into the form. The data contained in this two-dimensional barcode is then encrypted for security and authentication purposes and printed on the form when the user prints the form. When the printed form is received by the Data Collector at a central processing site, the two-dimensional barcode is scanned and decrypted, the form is authenticated, and the data is extracted virtually error-free

This application is a Continuation in Part of application Ser. No. 10/478,129, which was filed on Jun. 7, 2004, and which is the national phase under 35 U.S.C. §371 of PCT International Application No. PCT/US02/15948 which has an International filing date of May 21, 2002, which designated the United States of America.

### BACKGROUND OF THE INVENTION

1. Field of the Invention

This invention relates in general to computer software, and in particular to a method and system for increasing the accuracy and security of data capture from a paper form where the form was completed electronically and printed out prior to submission. The invention utilizes two-dimensional barcode technology to dynamically capture data entered electronically into the form. The data contained in this two-dimensional barcode is then encrypted for security and authentication purposes and printed on the form when the user prints the form. When the printed form is received by the Data Collector at a central processing site, the two-dimensional barcode is scanned and decrypted, the form is authenticated, and the data is extracted virtually error-free.

2. Description of the Background Art

Electronic forms applications consist of three primary components: design software for the Form Author, filler software for the End-User completing the form, and server software for the Form Distributor and/or Data Collector (the Form Distributor and the Data Collector may or may not be the same entity, and either may or may not be related to the Form Author).

The design software is used to create the electronic form (e-form), or user interface of the data container, as well as the algorithms associated with the e-form and data to be entered into the e-form. The Form Author may design the e-form as a traditional electronic form or integrate elements of hypertext markup language (HTML), extensible markup language (XML), portable document format (PDF), graphic elements (e.g., GIF, TIF. JPEG) and other objects to achieve the desired user interface. The designer may also specify data edits, validation, and other functions such as encryption, glyph generation, e-mail routing information, etc. that govern the behavior of the e-form in the filler application.

Filler software allows End Users to view and interact with the e-forms created using the design software. User interactions include filling out the e-form electronically, saving the e-form, printing the e-form, submitting the e-form, and similar functions depending on the algorithms associated with the e-form by the designer.

Server software allows form distributors and Data Collectors to process forms (e-forms and paper forms) automatically. For e-forms, the server software enables the Form Distributor to pre-fill forms with data from a database and distribute the pre-filled forms to End Users electronically (e.g., via email). Optionally, the distributor may encrypt the pre-filled data, or subsets of the pre-filled data, prior to distributing the e-forms. Server software also enables Data Collectors to process incoming e-forms electronically and automatically.

An example of such processing would be to receive the incoming e-form, identify the form, authenticate the form, decrypt the form, extract the data from the form, and write the data to a database. For paper forms, the server software enables Data Collectors to automatically extract the form data from the paper form by scanning a two-dimensional barcode containing the form data, decrypt the data extracted from the bar code, authenticate the form, and write the extracted data to a database.

Prior to this invention, if a Data Collector required the End User to submit the form on paper (as is the case if the form requires a ‘wet’ signature), the Data Collector had to rely on OCR/ICR/OMR, re-keying, or some other method to extract the data from the paper form.

These data extraction methods are prone to transcription errors, are costly, and cannot detect counterfeit forms. This invention allows Data Collectors to receive the printed form (with the ‘wet’ signature) and extract the data by scanning a two-dimensional barcode printed on the form. This method is more accurate than prior data extraction methods, because scanning a two-dimensional barcode is an all-or-nothing proposition: either it scans correctly, and the data is extracted exactly as it was entered into the form; or it doesn't scan at all, so no data errors are introduced via the scanning process (the form would have to go to exception processing instead). It is also more secure, since the data in the printed two-dimensional barcode is encrypted, ensuring that only an authorized party (such as the Data Collector) can extract the data electronically.

Counterfeit forms are not a new concept, but their likely frequency and the damage they can wreak on Data Collectors are dramatically increased in the world of PC-rendered paper forms (i.e., where, forms are obtained electronically by an End User and printed out by the End User before submission to the Data Collector). This scenario presents risks to the Data Collector, since a knowledgeable End User could conceivably alter a form before submitting it (either electronically or printed on paper). For example, using form design tools, an End User could change the perjury statement common to many forms to read as follows: “I do NOT declare under penalty of perjury . . . ”. The simple insertion of the word NOT in the perjury statement clearly violates the intention of the Data Collector. It then becomes a further obligation on the Data Collector to validate the authenticity of the submitted forms themselves, not just the data included on those forms. However, with this invention, the data imbedded in the two-dimensional bar code can only be successfully decrypted by an entity with the correct Form Lock password, or keyset. If the data cannot be decrypted with the correct Form Lock password, then the Data Collector or other authorized entity knows the form itself is counterfeit. The same is true for an electronic form submission, since the Data Collector will only be able to decrypt the data on the form if the original Form Lock password functions.

### SUMMARY OF THE INVENTION

The present invention disclosed herein comprises a method and system for increasing the accuracy and security of data capture from a paper form where the form was completed electronically and printed out on paper prior to submission, and in authenticating the printed form. The invention utilizes two-dimensional barcode technology to dynamically capture data entered electronically into the form. This two-dimensional barcode is then encrypted for security and printed on the form when the user prints the form. When the printed form is received by the Data Collector, the two-dimensional barcode is scanned and decrypted, and the data is extracted virtually error-free, eliminating the need for more costly, less efficient data extraction technologies and techniques. Successful decryption of the data authenticates the form as well, since the decryption will fail if the form has been altered or otherwise tampered with.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a graphic representation of a data processing system, according to an embodiment of the present invention;

FIG. 2 illustrates a two dimensional barcode, according to an embodiment of the present invention;

FIG. 3 illustrates the creation process of a two dimensional bar code according to an embodiment of the present invention; and

FIG. 4 illustrates an authentication and data retrieval process from a two dimensional bar code according to an embodiment of the present invention.

### DETAILED DESCRIPTION

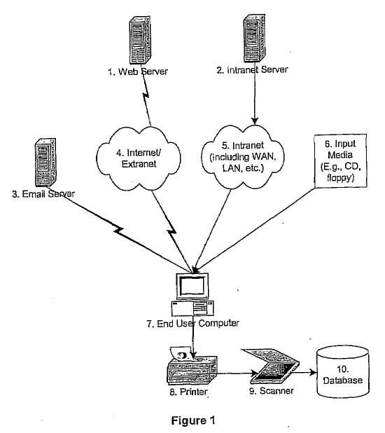

Referring to FIG. 1, there is depicted a graphic representation of a data processing system which may be utilized to implement the present invention. As may be seen, data processing system may include a plurality of networks, such as Local Area Network (LAN), Wide Area Network (WAN) and Internet, each of which may include a plurality of individual computers respectively. Those skilled in the art will appreciate that a plurality of workstations coupled to a host processor may be utilized for each such network. As is common in such data processing systems, each individual computer may be coupled to a storage device and/or printer/output device and/or input device.

The data processing system may also include multiple server computers, such as mainframe computer, which may be coupled to computer, LAN, WAN or Internet by means of communications link. The server computers may also be coupled to a storage device which may serve as remote storage for the End User computer, LAN, WAN or Internet.

Similarly, the End User computer, WAN and Internet may be coupled via communications link through a subsystem control unit/communications controller and communications link to a gateway server creating an inter-network link.

With respect to the End User computer, LAN, WAN and Internet, a plurality of documents or resource objects may be stored within storage device and controlled by a server computer, as resource manager or library service for the resource objects thus stored. Those skilled in the art will appreciate that the server computer may be located a great geographic distance from LAN and similarly, LAN may be located a substantial distance from the End User computer. For example, the End User computer may be located in Colorado while the LAN may be located in Washington and server computer may be located in New York.

Software program code which employs the present invention is typically stored in the memory of a storage device of a stand alone work station or storage device of a server computer from which a developer may access the code. For distribution purposes, the software program code may be embodied on any of a variety of known media for use with a data processing system, such as a diskette or CD-ROM or may be distributed to users from the memory of one computer system over a network of some type to other computer systems for use by users of such other systems. Such techniques and methods for embodying software code on media and/or distributing software code are well known and will not be further discussed herein.

With respect to the present invention, the End User 21 uses the End User computer 7 to access the e-form. The End User computer 7 is running software program code which employs the present invention. The e-form 20 is accessed directly from a storage device connected to the End User computer 7, such as a local hard drive, or from some form of input media 6, or from an email message from an email server 3, or from a communications link to the Internet/Extranet 4 and web server 1, or from a local Intranet 5 and Intranet server 2 or some similar access method. The End User 21 uses the End User computer 7 to view the eform 20, fill in data 22 in the data fields 23, save the eform 20, and to perform other similar actions. When the eform is completed and the End User prints the eform to the printer 8, the End User computer 7 carries out the instructions in the software program code which employs the present invention, creates the encrypted data set 24 from the field data contained in the eform 20 and prints the encrypted data along with identifying information 25 in a two-dimensional barcode 26 on the paper document 27. The printed document 27 is then sent to the Data Collector 28. When the Data Collector 28 receives the printed document 27, the document is scanned using scanner 9 which is attached to a scanning station. The scanning station is running software program code which employs the present invention to decipher the two dimensional barcode and process the data appropriately (identifying the originating form, authenticating the form, decrypting the encrypted data set, identifying the correct database, and writing the data to the database 10).

Once processed, the data may be written to a database 10 or some other storage device or passed to another system or application for continued processing or other purposes.

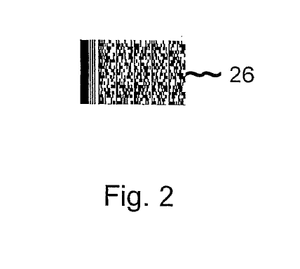

When the e-form 20 is being designed using the designer software, the designer selects a set of fields 29, 30 on the e-form for creating the dynamic two-dimensional barcode 26 (the 2D barcode field set). This set of fields can include all of the fields on the form or only a selected subset of fields on the form. The designer also selects an encryption key info 31, such as a password, that will be used to encrypt the data in the 2D barcode field set before it is printed on the paper form 27 as a two-dimensional barcode 26. An example of a common two-dimensional barcode, the PDF417, appears in FIG. 2. When the End User 21 opens the e-form 20 in the filler software, the End User can enter data via PC keyboard and mouse selections into the data fields 23 electronically (e.g., type in the data; click on pull-down menus to select specific item (s)). When the user is done filling out the form 20, the user 21 can print the form. When the user clicks the print button (or icon), the filler software automatically extracts the data from the 2D barcode field set, encrypts the data, and prints the two-dimensional barcode 26 containing encrypted data 24 onto the paper form 27. The printed two-dimensional barcode 26 also contains some unencrypted data 25 (e.g., form ID number, registration number, or similar identifying information) that is used to identify the form 20 when it is returned to the Data Collector 28. This process is transparent to the End User 21, except that the End User 21 will see a two-dimensional barcode 26 printed on the form 27. The End User 26 may then submit the printed form 27 to the Data Collector 28.

When the Data Collector 28 receives the printed form 27, the Data Collector 28 may scan the two-dimensional barcode 26 printed on the form 27 to extract the form data electronically. This is done using a conventional two-dimensional barcode scanner 9 and the server software. The scanner 9 scans the barcode and extracts the encrypted field data 24 from the barcode 26. The server software identifies the originating e-form 20 based on non-encrypted data 25 included in the two-dimensional barcode 26. The server software then applies the registered keyset associated with the e-form identification information 25 to decrypt the encrypted field data 24. Successful decryption of the dataset in the barcode 26 authenticates the form. After the data is decrypted it is written to a database 10.

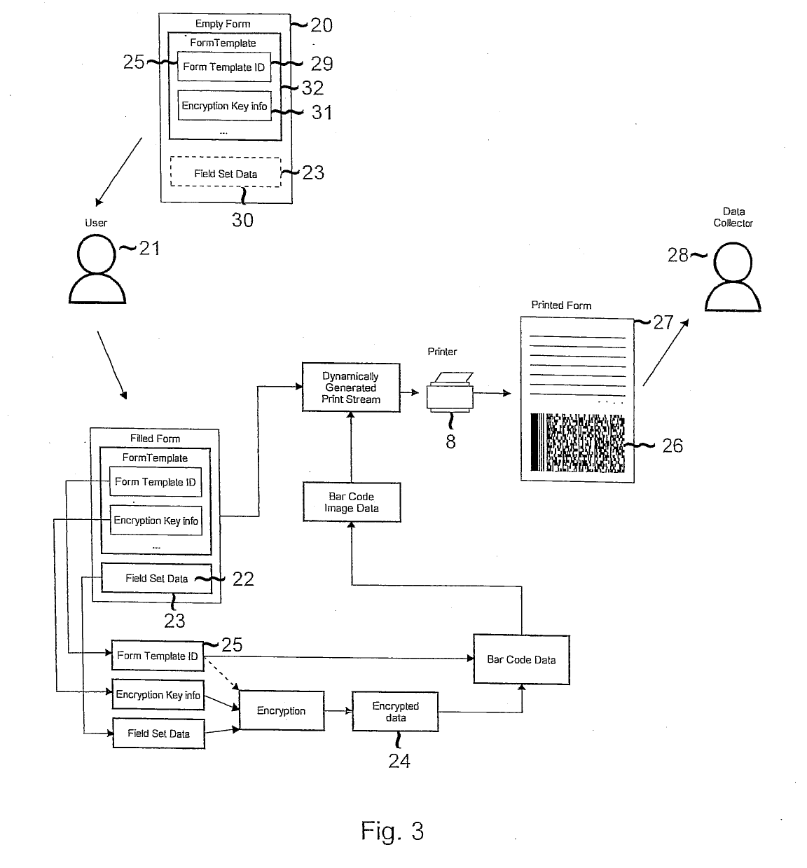

Referring to FIG. 3, a graphic representation of a data processing system, according to an exemplary embodiment of the present invention is shown for generating and printing an encrypted two-dimensional barcode 26 representing at least data 22 entered into an electronic form 20. A field set 23 is specified by the author (not shown) to identify the data 22 that will be encrypted and contained in the two-dimensional barcode 26. Also, names of fields in the field set 23 are specified, so that the fields correspond to fields in a database 10 associated with the electronic form 20. Also, field names and/or other identifying information 29 along with a field content for each field in the field set 23 are included, such that each field name and the respective field content are and remain associated with each other. The author also specifies an encryption key 31 that will be used to encrypt the data 22, and specifies form identification information 25, that may be included in the two-dimensional barcode 26 and may or may not be encrypted, for identifying the electronic form 20 when the electronic form is printed and scanned.

The two-dimensional barcode 26 may be provided on the printed electronic form 27, such that the data content of the two-dimensional barcode includes the data 22 entered into the form by the End User 21 and includes the form identification information 25.

The two-dimensional barcode 26 may also be generated when the End User 21 prints the electronic form 20, such that when the user, for example, clicks a print button, the data 22 and field identification information 25 from each field in the selected field set is extracted, the data 22 and field identification information 25 is encrypted with the specified encryption password, the identifying information may be included, but may not be encrypted, and the two-dimensional barcode 26 containing both the encrypted information 24 and the unencrypted identifying information 25 is printed on the form 27.

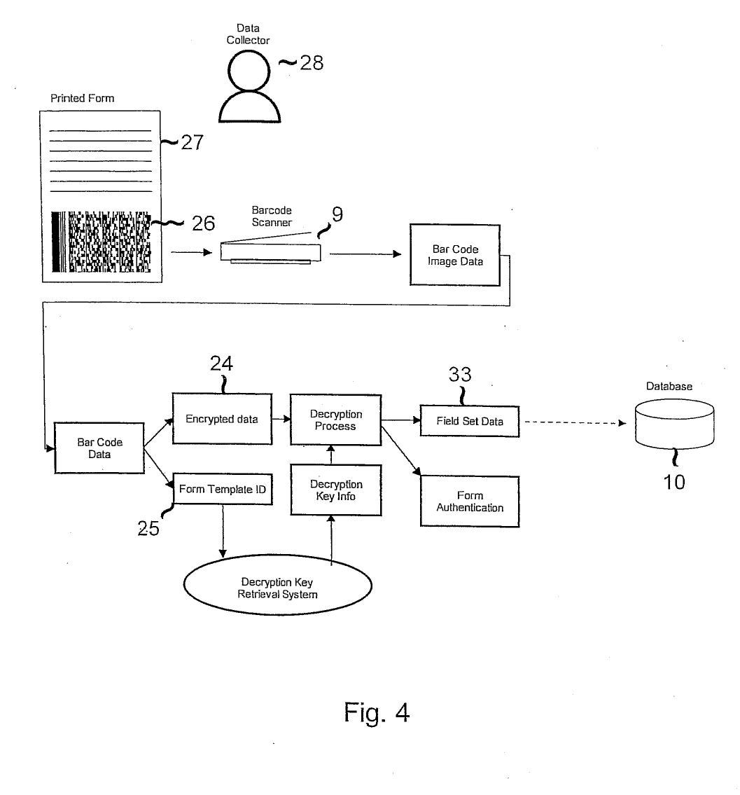

FIG. 4 illustrates an authentication and data retrieval process from a two dimensional bar code 26 according to an embodiment of the present invention. In order to extract data 22 from a printed, encrypted two-dimensional barcode 26, the two-dimensional barcode 26 is scanned with a two-dimensional barcode scanner 9. The electronic form template 29 is identified based on unencrypted identifying information 25 included in the two-dimensional barcode 26. The encryption key 31, which was used to encrypt the data 22 contained in the two-dimensional barcode 26 is retrieved based on an identification of the electronic form template 32. The encrypted data 24 contained in the two-dimensional barcode 26 is decrypted based on the encryption key 31. Optionally, at least one database 10 is identified to write the data 22 to based on the identification of the electronic form template 32, which is associated with the database 10. Thereafter, the decrypted data 33 is written to the database 10, such that the decrypted data 33 is written to at least one field in the database based on a field name from the electronic form template 20 and an associated database field. A person skilled in the art would understand that the decrypted data 33 can be written to one or more databases or be provided to other software applications.

In addition, in another exemplary embodiment, the printed version 27 of the electronic form 20 is authenticated from a printed and encrypted two-dimensional barcode 26. First, the two-dimensional barcode 26 is scanned with a two-dimensional barcode scanner 10. Then the electronic form template 20 is identified based on unencrypted identifying information 25 included in the two-dimensional barcode 26. Also, the encryption key 31 is retrieved in order to decrypt the data 22 contained in the two-dimensional barcode 26 based on the identification of the electronic form template 32. Next, the encrypted data 24 contained in the two-dimensional barcode 26 is decrypted, whereby the printed version 27 of the electronic form 20 is authenticated as the printed product 27 of the electronic form 20 based on a success or failure of the decryption process.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for generating and printing an encrypted two-dimensional barcode representing at least data entered into an electronic form, the method comprising:
specifying a field set to identify the data that will be encrypted and contained in the two-dimensional barcode;
specifying names of fields in the field set, so that the fields correspond to fields in a database associated with the electronic form;
including field names and/or other identifying information along with a field content for each field in the field set, such that each field name and the respective field content are and remain associated with each other;
specifying an encryption key that will be used to encrypt the data; and
specifying form identification information, that will be included in the two-dimensional barcode but not encrypted, for identifying the electronic form when the electronic form is scanned,
wherein the two-dimensional barcode is provided on the printed electronic form, such that the data content of the two-dimensional barcode includes the data entered into the form by the End User and includes the form identification information.

2. A method for extracting data from a printed, encrypted two-dimensional barcode, the method comprising:
scanning the two-dimensional barcode with a scanner;
identifying an electronic form template based on unencrypted identifying information included in the two-dimensional barcode;
retrieving an encryption key to decrypt the data contained in the two-dimensional barcode based on the identification of the electronic form template;
decrypting the encrypted data contained in the two-dimensional barcode;
identifying a database to write the data to based on the identification of the electronic form template, which is associated with the database; and
writing the decrypted data to the database, such that the decrypted data is written to at least one field in the database based on a field name from the electronic form template and an associated database field.

3. A method for authenticating a printed version of an electronic form from a printed and encrypted two-dimensional barcode, the method comprising:
scanning the two-dimensional barcode with a scanner;
identifying an electronic form template based on unencrypted identifying information included in the two-dimensional barcode;
retrieving an encryption key to decrypt the data contained in the two-dimensional barcode based on the identification of the electronic form template;
decrypting the encrypted data contained in the two-dimensional barcode; and
authenticating the printed version of the electronic form as the printed product of the electronic form template based on a success or failure of the decryption process.

4. The method according to claim 1, wherein an encrypted portion of the two-dimensional barcode is provided on the printed electronic form, such that data and field identification information from each field in the selected field set is extracted and the data and the field identification information is encrypted based on the specified encryption key.

5. The method according to claim 4, wherein the encrypted portion includes the data and field identification information and additional information.

6. The method according to claim 4, wherein the form identifying information is provided in an unencrypted portion of the two-dimensional barcode, and wherein the two-dimensional barcode containing both the encrypted portion and the unencrypted portion is printed on the form.

7. The method according to claim 2, wherein the encrypted data contained in the two-dimensional barcode is decrypted based on an encryption key password.

8. The method according to claim 3, wherein the encrypted data contained in the two-dimensional barcode is decrypted based on an encryption key password.

9. A two-dimensional barcode printed on a printed form, the printed form being generated by a user from an electronic form, the two-dimensional barcode comprising:
a non-encrypted portion for identifying an electronic form template; and
an encrypted portion representing encrypted data that includes at least data entered into a field on the electronic form.

10. The two-dimensional barcode according to claim 9, wherein a user enters the data into the field on the electronic form.

11. The two-dimensional barcode according to claim 9, wherein the data entered into the fields on the electronic form is subsequently extracted into at least one database.

12. The two-dimensional barcode according to claim 9, wherein the encrypted portion further comprises encryption key info.

13. The two-dimensional barcode according to claim 12, wherein the encryption key info is utilized for a subsequent verification process of the printed form.

14. The two-dimensional barcode according to claim 13, wherein the subsequent verification process is confirmed when the data entered by the user into the fields is extracted into a memory.

15. The two-dimensional barcode according to claim 9, wherein a form template identification identifies the electronic form template directly associated with the electronic form that generated the two-dimensional barcode.

16. The two-dimensional barcode according to claim 15, wherein the form template identification is associated with encryption key information to decrypt the data during a verification process.

17. A method for verifying an electronic form and for extracting data entered into the electronic form by a user, the method comprising:
providing the user with an electronic form, the user entering data into predetermined field sets, the electronic form including identification information for identifying an electronic form template and including encryption key info, the identification information facilitating an identification of the field sets for subsequent extraction of the data entered into the electronic form into associated fields in a database;
generating a two-dimensional barcode such that the two-dimensional barcode includes a non-encrypted portion based on the identification information for identifying the electronic form template, and includes an encrypted portion representing encrypted data that contains data entered into the electronic form and contains the encryption key info;
verifying the electronic form based on a successful decryption of the encrypted portion of the two-dimensional barcode; and
extracting the user entered data from the encrypted portion of the two-dimensional barcode into the associated fields in the database.

18. The two-dimensional barcode according to claim 9, wherein the encrypted portion further comprises encryption key info and a form template identification.
